(19) United States
(12) Patent Application Publication
(10) Pub. No.: US 2007/0294519 A1
(43) Pub. Date: Dec. 20, 2007

(54) Localized Control Caching Resulting In Power Efficient Control Logic

(76) Inventors: Laura F. Miller, Essex Junction, VT (US); Pascal A. Nsame, Colchester, VT (US); Nancy H. Pratt, Essex Junction, VT (US); Sebastian T. Ventrone, S. Burlington, VT (US)

Correspondence Address: DOWNS RACHLIN MARTIN PLLC, 199 MAIN ST, PO BO 190, BURLINGTON, VT, 05402-0190, US

(21) Appl. No.: 11/424,943

(22) Filed: Jun. 19, 2006

(51) Int. Cl. G06F 9/44

(52) U.S. Cl. 712/241

(57) ABSTRACT

An integrated circuit (IC) including a decoder decoding instructions, shadow latches storing instructions as a localized loop, and a state machine controlling the decoder and the plurality of shadow latches. When the state machine identifies instructions that are the same as those stored in the localized loop, it deactivates the decoder and activates the plurality of shadow latches to retrieve and execute the localized loop in place of the instructions provided by the decoder. Additionally, a method of providing localized control caching operations in an IC to reduce power dissipation is provided. The method includes initializing a state machine to control the IC, providing a plurality of shadow latches, decoding a set of instructions, detecting a loop of decoded instructions, caching the loop of decoded instructions in the shadow latches as a localized loop, detecting a loop end signal for the loop and stopping the caching of the localized loop.

### FIELD OF THE INVENTION

The present invention generally relates to the field of microprocessors. In particular, the present invention is directed to a localized control caching resulting in power efficient control logic.

### BACKGROUND OF THE INVENTION

Generally, microprocessor instructions are performed as a series of steps or stages. Different microprocessors break up an instruction into a number of different stages. For example, an instruction may include four stages: (1) fetch, (2) decode, (3) execute and (4) write. In order to complete the instruction, all four steps or stages must run in sequence.

Certain conventional processors work on one instruction at a time while sources sit idle waiting for the next fetch, decode, execute or write instruction, which is inefficient and slow. One technique to improve processor performance is to utilize an instruction pipeline. With “pipelining”, a processor breaks down an instruction execution process into a series of discrete pipeline stages which can be completed in sequence by hardware. Pipelining reduces cycle time for a processor and increases instruction throughput to improve performance in program code execution. For example, a conventional pipelining process with four instructions: A, B, C, and D, is illustrated in chart 72 of FIG. 6. All stages are active and an instruction does not have to wait until the previous instruction is complete. For example, Instruction B only has to wait for instruction A to complete its fetch stage, instead of waiting until instruction A has completed its write stage. Thus, pipelining a processor increases the number of instructions a CPU can execute in a given amount of time.

Conventional pipelined processors typically consume a substantial amount of power during the decode stage, approximately 40% of the power budget in a chip. Accordingly, it is highly desirable to reduce the amount of power consumption during execution of a pipeline instruction in a microprocessor chip, particularly decode instructions.

### SUMMARY OF THE DISCLOSURE

In one aspect, an integrated circuit is disclosed. The integrated circuit includes a decoder operable for decoding a plurality of instructions, a plurality of shadow latches in communication with the decoder, the plurality of shadow latches storing the plurality of instructions as a localized loop and a localized control caching state machine operable for controlling the decoder and the plurality of shadow latches. The state machine evaluates instructions provided to the decoder. When the state machine identifies instructions that are the same as those stored as the localized loop, it deactivates the decoder and activates the plurality of shadow latches to retrieve and execute the localized loop in place of the instructions provided from the decoder.

The disclosure also provides a multiprocessing super scalar processor. The multiprocessing super scalar processor includes a decoder operable for decoding a plurality of instructions, a plurality of block execution control units operable for executing the plurality of instructions and a localized control caching state machine operable for controlling the decoder and the plurality of block execution control units. Each of the plurality of block execution control units includes a plurality of shadow latches designed for storing the plurality of instructions as a localized loop.

The disclosure also covers a method of providing localized control caching operations in an integrated circuit to reduce power dissipation. The method includes initializing a state machine with circular queue logic to control the integrated circuit, providing a plurality of shadow latches within the integrated circuit, the plurality of shadow latches controlled by the state machine, detecting the number of shadow latches within the integrated circuit of the state machine, decoding a set of instructions with a decoder, the decoder in communication with the plurality of shadow latches and the state machine, detecting a loop of decoded instructions with the state machine, caching the loop of decoded instructions in the plurality of shadow latches as a localized loop, detecting a loop end signal for the loop and stopping the caching of the localized loop.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates a schematic block diagram of one embodiment of a processor system;

FIG. 2 illustrates a localized caching control unit with a plurality of shadow latches;

FIG. 3 illustrates another localized caching control unit with a plurality of shadow latches;

FIG. 4 illustrates a schematic block diagram of yet another localized caching control unit with a plurality of shadow latches;

FIG. 5 illustrates a flowchart for a power efficient decoding process; and

FIG. 6 illustrates a timing chart comparing a conventional system and one embodiment of the processor system of the present disclosure.

### DETAILED DESCRIPTION

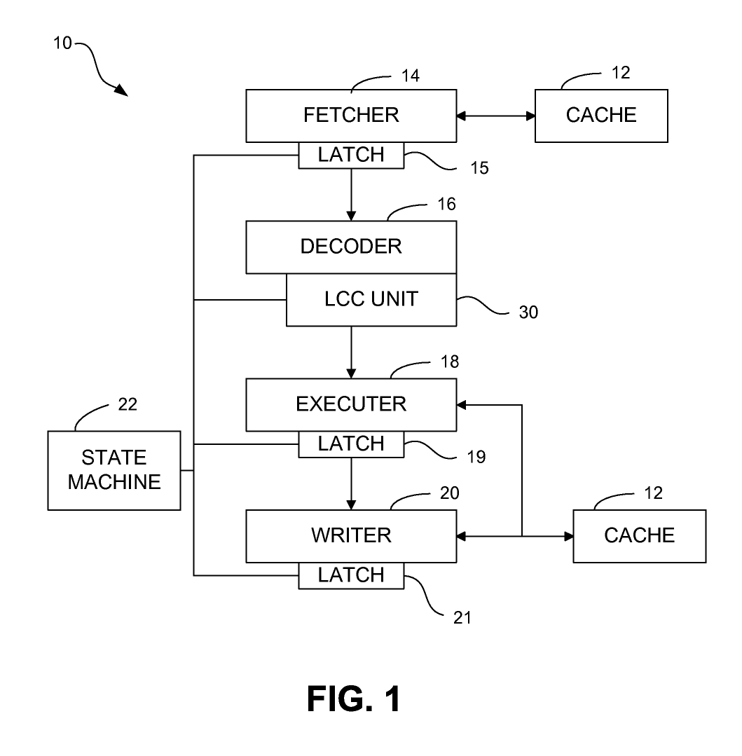

Referring now to FIG. 1, a processor system 10 performing a pipeline of steps or stages, according to one embodiment of the present disclosure, is illustrated. In this illustrative embodiment, system 10 performs the steps of: fetch, decode, execute and write. It should be understood that the number of steps performed by system 10 may be increased or decreased according to the application requirements for the processor system while keeping within the scope and spirit of the present disclosure.

System 10 includes a cache 12 for providing and storing instructions, a fetcher 14 for fetching instructions from the cache with a data latch 15, a decoder 16, with a localized control cache (LCC) unit 30 for decoding instructions received from the fetcher, and an executor 18 for executing the instructions with a data latch 19. System 10 also includes a writer 20 for writing the instructions back to the cache with a data latch 21, and a LCC state machine 22 which tracks the address values of instructions and controls all the components of the system. All the components of system 10 discussed above are coupled via a coupling circuitry (not shown) to allow communications and exchange of data and signals, as is well known in the art. Decoder 16 may also be referred to as a logic cone which performs the decoding functions. Data latches 15, 19 and 21 generally save data for only one cycle with no data caching or storing capability. Cache 12 may also include a program counter register, an instruction register, and data registers (none of these registers are shown) for providing instructions to and storing instructions from system 10.

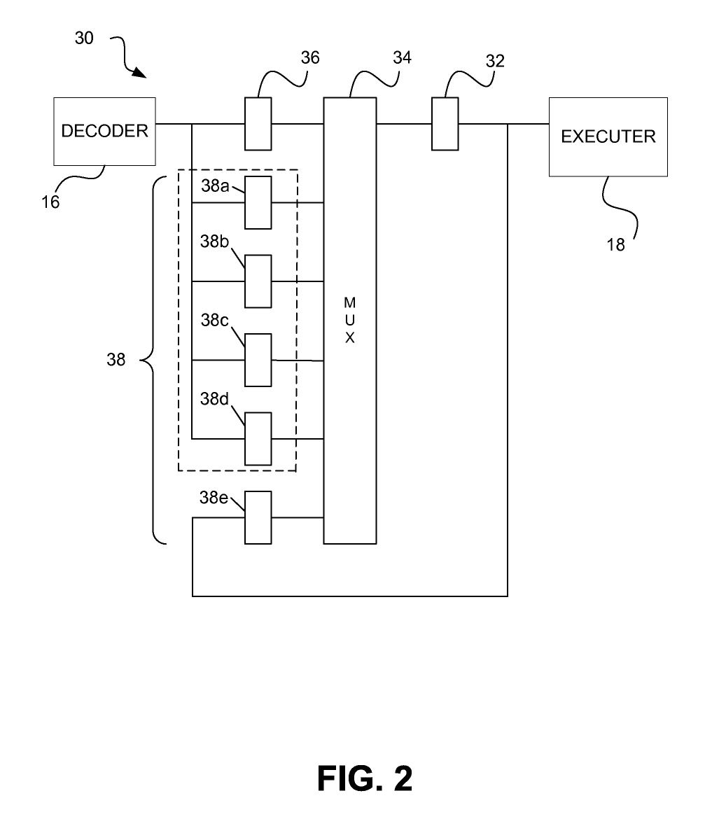

Referring now to FIGS. 1 and 2, LCC unit 30, according to one embodiment of the disclosure, is illustrated in greater detail in FIG. 2. LCC unit 30 receives a data instruction signal from fetcher 14 and produces an output instruction signal to executer 18. LCC unit 30 includes a first system latch 32 and 36, and a multiplexer 34 connected to the first system latch so as to receive an instruction signal provided by the second system latch. LCC unit 30 also includes a second system latch 36 connected to the multiplexer. Second system latch 36 may be a low power latch and is provided to store prior state information so that previous states may be recovered. LCC unit 30 also includes and a plurality of shadow latches 38 connected to multiplexer 34. Shadow latches 38 are similar to the shadow latches disclosed in U.S. Pat. No. 5,986,962 issued to Bertin et. al on Nov. 16, 1999 and entitled “INTERNAL SHADOW LATCH,” which is hereby incorporated by reference in its entirety. Shadow latches 38 are labeled sequentially as 38a, 38b, 38c, 38d, and 38e, for illustrative purposes. In this embodiment, shadow latch 38e, is not connected in series with other shadow latches 38a-38d. Shadow latch 38e serves as the shadow register for performing decoding functions during an underflow condition, which is discussed in greater detail below. Shadow latch 38e performs the operation of first system latch 32 during an underflow condition. The number of shadow latches 38 utilized is variable depending on the application and/or the amount of space available on the processor chip. Accordingly, a greater or lesser number of shadow latches 38 may be utilized while keeping within the scope and spirit of the present invention.

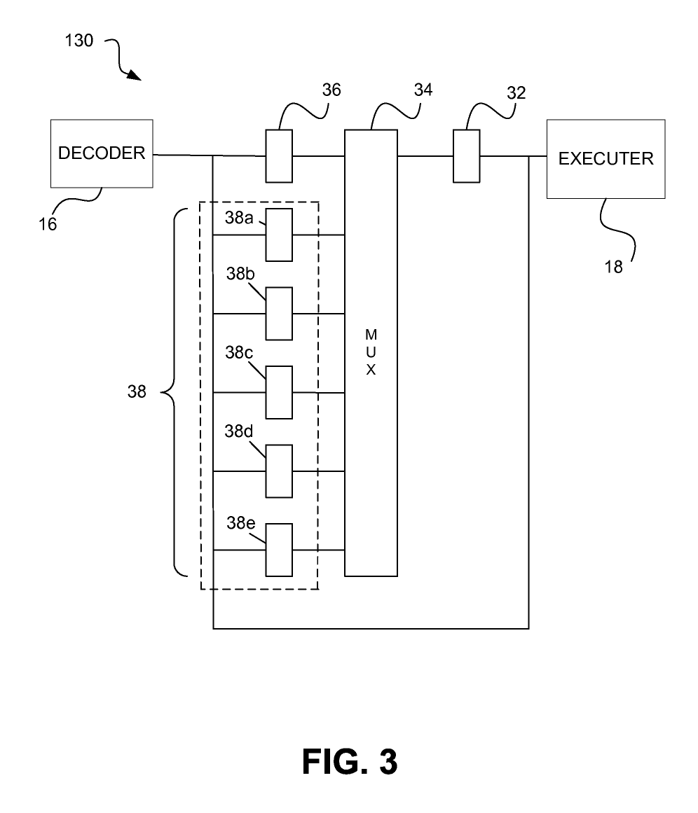

Referring now to FIG. 3, LCC unit 130, according to another embodiment of the disclosure, is illustrated. LCC unit 130 operates in a substantially similar manner to LCC unit 30, as discussed above. However, the last shadow latch, 38e, is connected in series with the other shadow latches and can serve as the last shadow latch or as the underflow system latch, discussed further below.

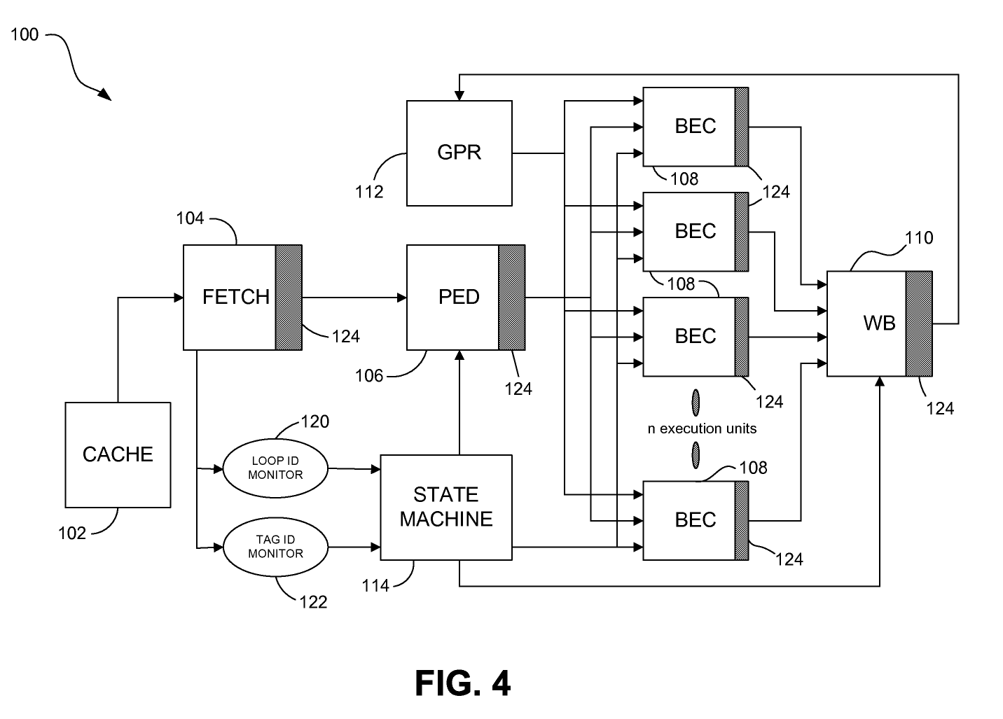

FIG. 4 illustrates a super scalar processor system 100, in accordance with another embodiment of the present disclosure. System 100 includes a cache 102 which provides data and instructions to the system, a fetcher 104 for retrieving instructions from the cache for processing by the system, and a power efficient decoder 106 receiving instructions from the fetcher. System 100 also includes a plurality of block execution control (BEC) units 108 for receiving instructions from decoder 106, a writer 110 for receiving instructions from the plurality of the BEC units to write to a general purpose register 112, and an LCC state machine 114 which controls all the components and devices of the system.

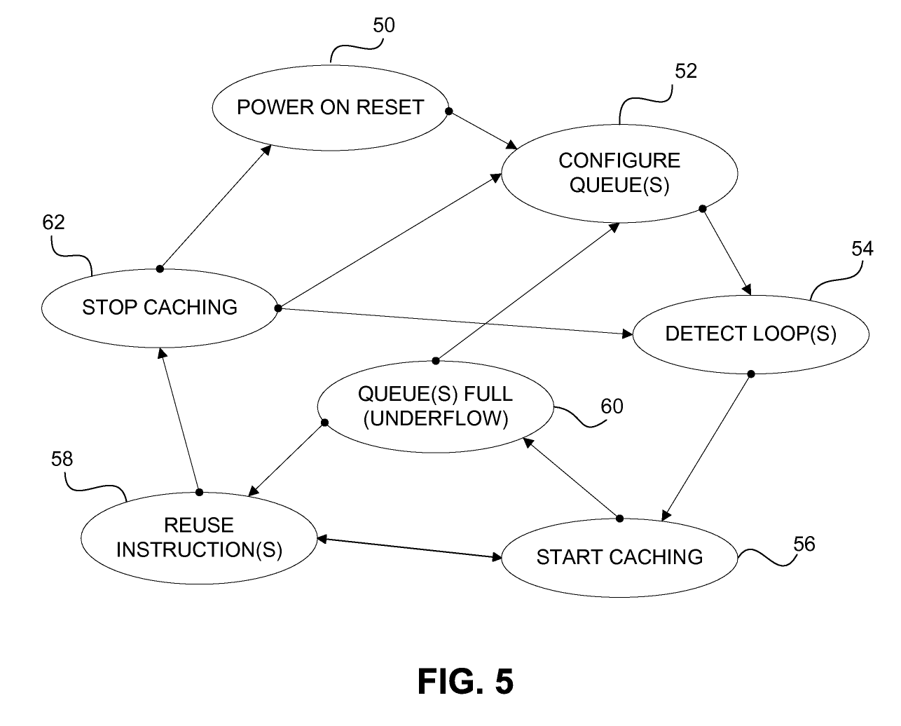

System 100 performs in substantially the same manner as system 10, i.e., it performs the pipeline stages of fetching, decoding, executing and writing. However, each BEC unit 108 contains a plurality of shadow latches (not shown) that can store and cache instructions. Accordingly, system 100 can store a plurality of different loops in each of the plurality of BEC units 108 that can be accessed via state machine 114. BEC units 108 have a similar configuration to LLC units 30 and 130, as illustrated in of FIGS. 2 and 3, respectively, wherein a plurality of shadow latches 38 are utilized to store and cache a localized set of instructions or a loop. System 100 also includes a loop ID monitor 120 and a tag ID monitor 122 coupled between fetcher 104 and state machine 112. Loop ID monitor 120 assists state machine 112 detect an occurrence of a loop using a circular queue control logic described more below and illustrated in FIG. 5. Tag ID monitor 122 assists state machine 112 catalog the plurality of loops, such that the state machine knows where each loop is stored in plurality of BEC units 108.

Additionally, a circular queue structure 124 is provided on each element of the pipeline stages (e.g., on fetcher 104, power efficient decoder 106, BEC 108, and writer 110) for communication with state machine 114, which uses circular queue control logic, described more below, to operate the processor with localized caching in plurality of shadow latches 38 in each BEC. The circular queue control logic allows a localized copy of the instructions, generally the decode instructions, to replace the random logic generation of the same control signals. Circular queue control logic utilizes a start pointer, a stop pointer, a flush, a partial flush, and a don't care state, to detect and retrieve loops, as is well known in the art. The instruction loop may be user-defined or function dependent upon execution, where the same sequences of instructions are performed.

Operation of circular queue control logic for power efficient decoding performed by LLC state machine 22 is illustrated in a flowchart in FIG. 5. Referring to FIG. 5 and also to FIGS. 1-3, system 10 is first turned on or reset at step 50, state machine 22 dynamically configures queue depth at step 52 to determine how many shadow latches are available for storage of instructions, also referred to as a cache depth. The instructions are received and processed by LCC system 30, via latch 36, multiplexer 34 and latch 32. As the instruction process continues, state machine 22 tracks address values for instructions as well as the depth of the loop, or loop depth. The logic of state machine 22 can detect the return of a code sequence by detecting any branch/jump instructions to detect loop or loops at step 54. When a loop is initially detected, state machine 22 queues plurality of shadow latches 38 to start caching or storing instructions at step 56. Each shadow latch 38 can save a new decode state, a don't care state, or a clock saved state. Thus, the instruction is performed at latch 36 and then multiplexer 34 stores the instruction in a sequential order into plurality of latches 38.

Control logic detects the return of a code sequence by detecting any branch/jump instructions. When conditional values are true, a loop will occur and is detected again at step 54. Decoder 16 is then deactivated and the sequence is now processed thru via state machine 22 by multiplexer 34 which outputs control to plurality of shadow latches 38 to reuse instruction streams or loops at step 58. The decode values are now retrieved from plurality of shadow latches 38, and the previous control inputs at the start of the decode cycle are locked down, or clock gated. For the entire loop control sequences, no decode functions will be allowed to process resulting in zero AC power for the skipped decode cycles. The process may continue at step 62, when the caching stops and the process can go to steps 52 or 54, and repeat the process over again, or go the reset mode at step 50.

An overflow condition is where the cache depth is greater than the loop depth. Thus, an underflow condition exists when the loop depth is greater than the cache depth. The overflow condition happens when the loop has been completely stored with shadow latches 38 remaining open or unused. When state machine 22 uses a history/event trace to detect a request for the loop stored in shadow latches 38, the state machine commands the shadow latches to reuse the instruction streams at step 58. Thus, latch 36 is disabled and bypassed and the instructions are obtained from latch 38a to multiplexer 34 and then latch 32, then latch 38b to multiplexer 34 to latch 32, and so on. Additionally during step 58, state machine 22 will deactivate latch 36, decoder 16, executor 18, and writer 20.

In underflow conditions where the instruction stages or steps (loop depth) exceed the number of queues (cache depth) available in shadow latches 38, state machine 22 selects an underflow path for those cycles, where those excess cycles or instructions are not cached. State machine 22 detects a request for the loop stored in shadow latches 38, and the state machines commands the shadow latches to reuse the instruction streams at step 58. During step 58, and state machine 22 will deactivate decoder 16, executor 18, and writer 20, as previously discussed. Shadow latches 38 will perform the instructions stored and then the excess instructions (non-shadowed cycles) will be performed by the last shadow latch 38e, which may be designated as an underflow latch, which has been designated by state machine 22 to perform all the remaining instruction steps of the loop. In overflow conditions, decoding of the excess instructions would be decoded conventionally. In underflow conditions, the non-shadowed cycles would activate decoder 16, 124 or logic cone to decode the function. When the loop returns to the start, the contents of shadow latches 38 are used, until the overflow cycles are reached.

While the preceding discussion of the operation of system 10 was provided with respect to system 10 having LCC units 30, those skilled in the art will appreciate that this description also applies to other embodiments of the invention featuring LCC units 130 or BEC units 108.

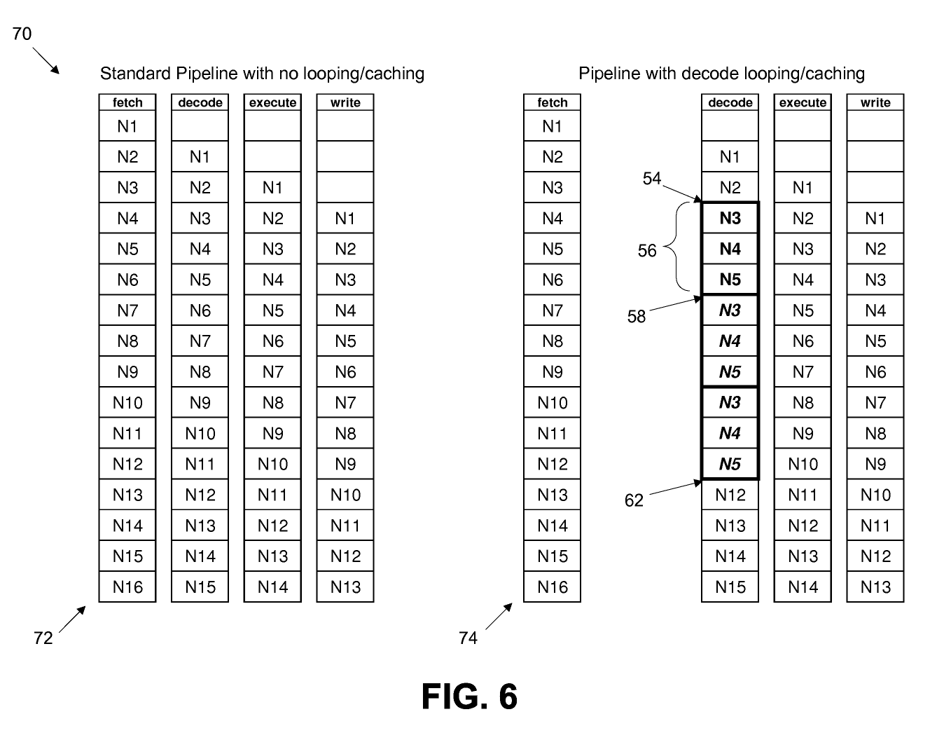

Referring now to FIG. 6, a processor timing comparison chart 70 is illustrated showing a conventional pipeline chart 72 with no looping or caching and a localized caching control chart 74 with decode looping and caching. FIG. 6 illustrates some of the steps from FIG. 5 according to one embodiment of the disclosure. Chart 72 illustrates how every instruction is decoded. Generally, decoding an instruction in conventional pipelines consumes approximately 40% of the power budget for a chip, accordingly any reduction of decoding would result in a substantial overall circuit power savings.

Chart 74 provides over time for the process according to one embodiment of the present disclosure. Chart 74 depicts an overflow condition where the queue depth has already been configured, as may occur in step 52. At step 54, state machine 22, 114 detects a loop, and begins to start caching, as occurs at step 56. In this illustrative example, three instructions, N3, N4, and N5, make up the loop. Loops with a greater or lesser number of instructions can be utilized while still keeping within the scope and spirit of the present invention. At the end of the caching, state machine 22, 114 detects that the loop has been requested and thus the loop, cached in the plurality of shadow latches 38, is activated, as indicated in step 58. In the illustrative embodiment of FIG. 6, the loop is repeated twice. However, it is noted that a loop may be repeated many more times, potentially thousands of times, resulting in bigger power savings. When state machine 22 detects the end of the loop at step 62, the state machine stops caching and the program continues, in this illustrative example, continuing with instructions N 12 and so on.

Chart 74 would operate in a similar manner for underflow conditions. Thus the stored instructions would be executed in the same manner, with the underflow latch 38e performing the conventional decoding in the remaining steps or stages in the loop.

Exemplary embodiments have been disclosed above and illustrated in the accompanying drawings. It will be understood by those skilled in the art that various changes, omissions and additions may be made to that which is specifically disclosed herein without departing from the spirit and scope of the present disclosure.

What is claimed is:

1. An integrated circuit comprising:
a decoder operable for decoding a plurality of instructions;
a plurality of shadow latches in communication with said decoder, said plurality of shadow latches storing said plurality of instructions as a localized loop; and
a localized control caching state machine operable for controlling said decoder and said plurality of shadow latches, wherein said state machine evaluates instructions provided to said decoder and when it identifies instructions that are the same as those stored as said localized loop, said state machine deactivates said decoder and activates said plurality of shadow latches to retrieve and execute said localized loop in place of said instructions provided from said decoder.

2. An integrated circuit of claim 1, further comprising:
an executer for executing said plurality of instructions;
a first system latch in communication with said executer, said first system latch sending said plurality of instructions to said executer;
a multiplexer coupled with said first system latch, said multiplexer sending said plurality of instructions to said first system latch;
a second system latch coupled with said decoder and said multiplexer, said second system latch sending said plurality of instructions to said multiplexer;
wherein said state machine controls said executer, said first system latch, said multiplexer, and said second system latch so that when said state machine detects instructions provided to said decoder that are the same as those instructions stored as said localized loop, said state machine deactivates said decoder and said second system latch and activates said first system latch and said multiplexer to communicate with said plurality of shadow latches to retrieve and execute said localized loop in place of said instructions provided to said executer.

3. An integrated circuit of claim 1, wherein said decoder comprising a logic cone.

4. An integrated circuit of claim 1, wherein when the number of instructions of said localized loop exceeds the number shadow latches in said plurality of shadow latches, excess instructions exist resulting in an underflow condition, further wherein said state machine determines an underflow path for decoding said excess instructions.

5. An integrated circuit of claim 4, wherein said underflow path includes at least one of said plurality of shadow latches designated to decode said excess instructions.

6. An integrated circuit of claim 4, wherein said state machine activates said second system latch when an underflow condition exists so as to cause said second system latch to perform said excess instructions.

7. An integrated circuit of claim 1, wherein at least two localized loops of instructions are stored in said plurality of shadow latches.

8. An integrated circuit of claim 1, further comprising:
a fetcher for fetching said instructions; and
a writer for writing said instructions from said executer;
wherein said state machine controls said fetcher and said writer.

9. A multiprocessing super scalar processor comprising:
a decoder operable for decoding a plurality of instructions;
a plurality of block execution control units operable for executing said plurality of instructions, wherein each of said plurality of block execution control units includes a plurality of shadow latches designed for storing said plurality of instructions as a localized loop; and
a localized control caching state machine operable for controlling said decoder and said plurality of block execution control units.

10. A multiprocessing super scalar processor of claim 9, wherein each of said plurality of block execution control units further includes:
a first system latch;
a multiplexer coupled with said first system latch, said multiplexer sending said plurality of instructions to said first system latch, wherein said multiplexer communicates with said plurality of shadow latches to access said localized loop so as to provide said localized loop to said first system latch;
a second system latch in communication with said decoder and multiplexer, and operable for sending said plurality of instructions to said multiplexer; and
wherein said state machine evaluates instructions provided to said decoder and when it identifies instructions that are the same as those stored as said localized loop in one of said plurality of block execution control units, said state machine deactivates said decoder and activates said multiplexer, said first system latch and said associated plurality of shadow latches to retrieve and execute said localized loop in place of said instructions provided to said plurality of block execution control units.

11. A multiprocessing super scalar processor of claim 9, wherein at least two localized loops of instructions are stored in said plurality of shadow latches of at least one of said plurality of block execution control units.

12. A multiprocessing super scalar processor of claim 9, wherein said decoder comprising a logic cone.

13. A multiprocessing super scalar processor of claim 9, further comprising:
a fetcher operable for fetching said plurality of instructions; and
a writer in communication with said decoder, said writer operable for writing said plurality of instructions to a general purpose register;
wherein said localized control caching state machine controls said fetcher and said writer such that when said state machine detects instructions provided to said decoder that are the same as instructions stored as said localized loop in one of said plurality of block execution control units.

14. A multiprocessing super scalar processor of claim 13, wherein said localized control caching state machine deactivates said fetcher when said state machine detects instructions provided to said decoder that are the same as instructions stored as said localized loop in one of said plurality of block execution control units.

15. A method of providing localized control caching operations in an integrated circuit to reduce power dissipation, the method comprising:
initializing a state machine with circular queue logic to control the integrated circuit;
providing a plurality of shadow latches within the integrated circuit, the plurality of shadow latches controlled by the state machine;
detecting the number of shadow latches within the integrated circuit of the state machine;
decoding a set of instructions with a decoder, the decoder in communication with the plurality of shadow latches and the state machine;
detecting a loop of decoded instructions with the state machine;
caching the loop of decoded instructions in the plurality of shadow latches as a localized loop;
detecting a loop end signal for the loop; and
stopping the caching of the localized loop.

16. A method of claim 15, the method further comprising:
detecting instructions that are the same as those stored as in the localized loop by the state machine;
deactivating the decoder by the state machine; and
retrieving the localized loop from the plurality of shadow latches; and
executing the localized loop.

17. A method of claim 15, the method further comprising:
storing a plurality of localized loops in the plurality of shadow latches;
performing a history/event trace of the instructions by the state machine;
detecting at least one of the plurality of localized loops stored in the plurality of shadow latches;
deactivating the decoder by the state machine;
retrieving the associated localized loop from the associated plurality of shadow latches;
executing the associated localized loop;
detecting the loop end signal;
deactivating the plurality of shadow latches; and
activating the decoder.

18. A method of claim 15, the method further comprising:
storing at least two loops of decoded instructions in the plurality of shadow latches.

19. A method of claim 15, the method further comprising:
detecting the number of instructions in the localized loop exceeds the number of shadow latches available resulting in excess instructions for an underflow condition; and
determining a flow path for decoding the excess instructions by the state machine.

20. A method of claim 19, the method further comprising:
selecting one of the plurality of shadow latches for decoding the excess instructions in the flow path.
